(19) United States
(12) Patent Application Publication
(10) Pub. No.: US 2015/0365770 A1
(43) Pub. Date: Dec. 17, 2015

(54) MEMS Device With Optical Component

(71) Applicant: Knowles Electronics, LLC, Itasca, IL (US)

(72) Inventor: Eric J. Lautenschlager, Geneva, IL (US)

(21) Appl. No.: 14/728,056

(22) Filed: Jun. 2, 2015

Related U.S. Application Data
(60) Provisional application No. 62/010,592, filed on Jun. 11, 2014.

(51) Int. Cl. H04R 23/00; H04R 1/04

(52) U.S. Cl. CPC H04R 23/008; H04R 1/04; H04R 2201/003

(57) ABSTRACT

A micro electro mechanical system (MEMS) microphone includes a lid, at least one wall coupled to the lid, a substrate, and a MEMS die. The substrate is coupled to the at least one wall and a port extending through the substrate. The MEMS die is disposed on the substrate, and the MEMS die including a movable diaphragm and back plate. The optical sub-assembly is coupled to the lid, and the optical sub-assembly is configured and arranged to sense a position of the diaphragm.

### CROSS REFERENCES TO RELATED APPLICATION

This patent claims benefit under 35 U.S.C. §119 (e) to U.S. Provisional Application No. 62/010,592 entitled “MEMS device with Optical Component” filed Jun. 11, 2014, the content of which is incorporated herein by reference in its entirety.

### TECHNICAL FIELD

This application relates to acoustic devices and, more specifically, to acoustic devices that use optical components.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)).

A MEMS die typically has disposed on it a diaphragm and a back plate. Changes in sound energy move the diaphragm, which changes the capacitance involving the back plate electrode thereby creating an electrical signal. The MEMS dies is typically disposed on a base or substrate along with the ASIC and then both are enclosed by a lid or cover. The sound energy enters the microphone through a port or opening. When the port is disposed on the lid of the microphone, the microphone is typically referred to as a top port device. The port can also extend through the substrate or base. In this case, the microphone is typically known as a bottom port device.

Different types of optical devices and systems exist. For example, laser devices are used for various purposes in optical systems. Different types of optical sensors also exist. For example, different types of optical sensors may measure the intensity, or spatial diffraction patterns of light.

### BRIEF DESCRIPTION OF THE DRAWINGS

For a more complete understanding of the disclosure, reference should be made to the following detailed description and accompanying drawings wherein:

FIG. 1 comprises a perspective view of a MEMS bottom port microphone with optical components according to various embodiments of the present invention;

FIG. 2 comprises a vertical cross-sectional view of the MEMS bottom port microphone with optical components of FIG. 1 along line A-A according to various embodiments of the present invention;

FIG. 3 comprises a perspective view of a MEMS top port microphone with optical components according to various embodiments of the present invention;

FIG. 4 comprises a vertical cross-sectional view of a MEMS top port microphone with optical components of FIG. 3 along line B-B according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein

### DETAILED DESCRIPTION

Approaches are described that utilize optical components (for example, in the form of an optical detection sub-assembly) in microelectromechanical (MEMS) microphones. The optical components are used to determine and/or measure diaphragm movement when sound is sensed by the microphone, and can then be used to create an electrical signal that is representative of the sound received by the microphone.

The present approaches, in one aspect, do not dispose the optical sub-assembly or optical components under the MEMS die. In one advantage of the present approaches, a smaller MEMS die may be utilized since the MEMS die does not enclose the optic components. In another advantage of the present approaches, smaller microphone package sizes are provided than if the optical components are positioned under the MEMS die. In still other advantages, the present approaches can be utilized with both top port and bottom port devices. Moreover and since the optical components sense diaphragm movement directly, a back plate and corresponding capacitive electrode is no longer needed by the MEMS microphone thereby saving expenses and simplifying manufacturing.

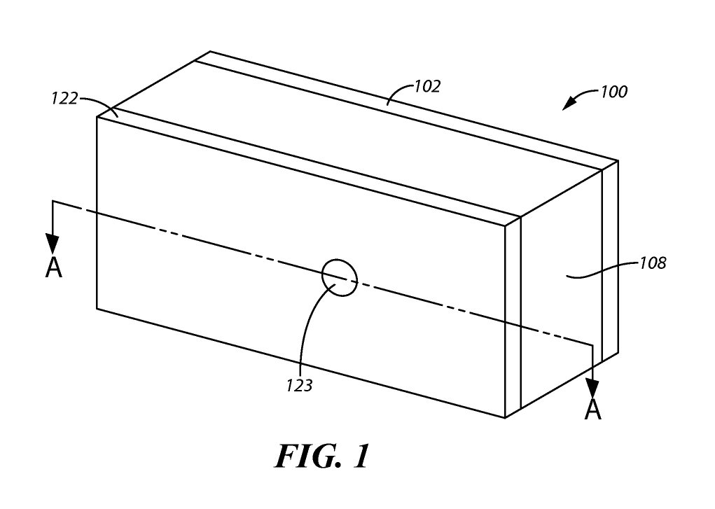

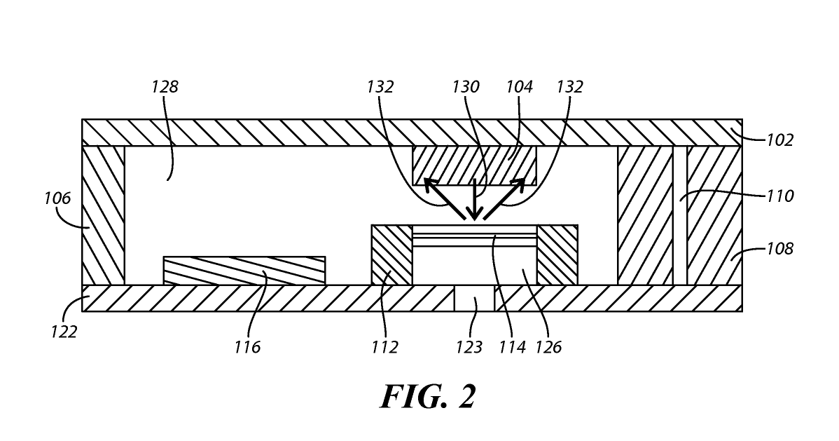

Referring now to FIG. 1 and FIG. 2, one example of a MEMS microphone 100 is described. The MEMS microphone 100 includes a lid 102, an optical sub-assembly 104 (that is coupled to the lid 102), a first wall 106, a second wall 108 (that includes conductive vias 110), a MEMS die 112 (including a diaphragm 114), and an application specific integrated circuit (ASIC) 116.

The optical sub-assembly 104 may include a laser that emits light 130 and photo detectors (photo diodes) that measure light, 132. The laser emits the light 130 which impacts a diffraction grating produced on the MEMS diaphragm 114, and is reflected back to the sub-assembly 104, as the return light signal 132. The photo detectors in the optical sub-assembly 104 detect the intensity of the return light 132. The intensity of the return light 132, varies as a function of the travel distance of the light signal, which is a direct measure of the position of the diaphragm. Therefore, as the diaphragm 114 moves in response to the sound field, the distance between it and the optical sub-assembly 104 changes, and can be optically detected and used to measure the sound signal.

The sensing light signal obtained by the sub-assembly 104 may be communicated through a conductive path (not shown) through the lid 102, through vias 110, and then through conductive traces (not shown) in the base 122 to the ASIC 116, which can further process the signals and can determine the distance the diaphragm 114 moves. The processing creates an electrical signal representative of the received sound. This electrical signal, in turn can be communicated to external devices from the ASIC 116 to external pads (not shown) on the substrate 122. A customer can couple their device to these pads and in one aspect further utilize or process the signal.

The lid 102, first wall 106, and a second wall 108 may be manufactured from an FR4 material in one example. The MEMS die 112, the walls 106 and 108, and the ASIC 116 are disposed on a base or substrate 122. A port or opening 123 extends through the substrate 122 and into the MEMS 112 under the diaphragm 114 forming a front volume cavity 126. A back volume 128 is formed by the walls 106 and 108, lid 102, substrate 122 and is separated from the front volume 126 by the diaphragm 114. The ASIC 116 can provide various processing functions.

As will be appreciated, in this example, the optical sensor is located external to or outside the MEMS die and, in this case, is directly above (as compared to being in the MEMS cavity 126) the MEMS die. As also will be appreciated, no back plate is required since it is the optical sensor 104 that determines the movement of the diaphragm 114 and hence recovers the incident sound.

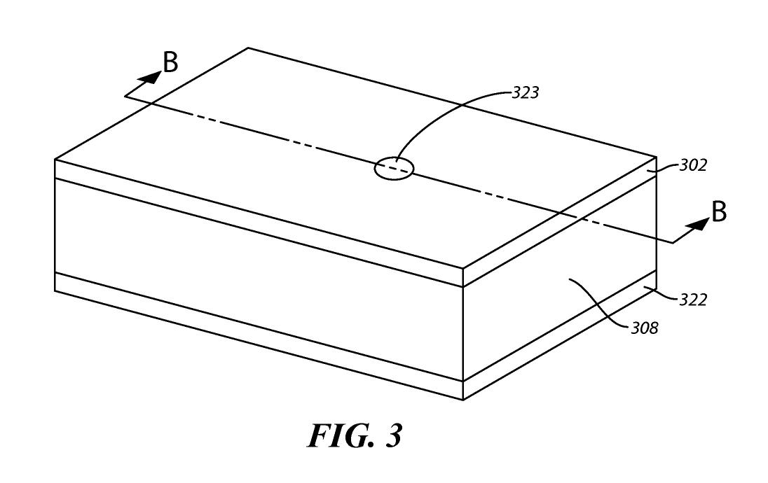

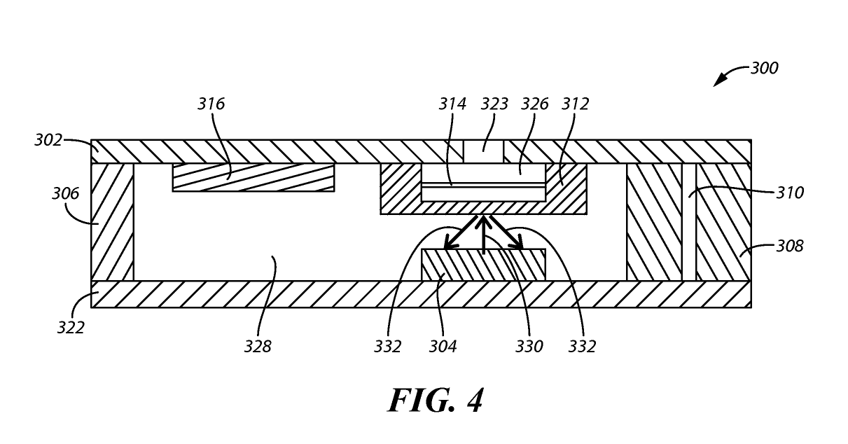

Referring now to FIG. 3 and FIG. 4, another example of a MEMS microphone 300 is described. The MEMS microphone 300 includes a lid 302, an optical sub-assembly 304, a first wall 306, a second wall 308, a MEMS die 312 (including a diaphragm 314), and an application specific integrated circuit (ASIC) 316.

The optical sub-assembly 304 may include a laser that emits light 330 and photo detectors (photo diodes) that measure light, 332. The laser emits the light 330 which impacts a diffraction grating produced on the MEMS diaphragm 314, and is reflected back to the sub-assembly 304, as the return light signal 332. The photo detectors in the optical sub-assembly 304 detect the intensity of the return light 332. The intensity of the return light 332, varies as a function of the travel distance of the light signal, which is a direct measure of the position of the diaphragm. Therefore, as the diaphragm 314 moves in response to the sound field, the distance between it and the optical sub-assembly 304 changes, and can be optically detected and used to measure the sound signal.

This sensing light information may be communicated from the sub-assembly 304 through a conductive path (not shown) through conductive traces (not shown) in the base 322 to the ASIC 316, which can process the signals and can determine the distance the diaphragm 314 moves. This information is used to create an electrical signal representative of the received sounds. This electrical signal, in turn can be communicated to external devices from the ASIC 316 to external pads (not shown) on the substrate 322. A customer can couple their device to these pads and in one aspect further utilize or process the signal.

The lid 302, first wall 306, and a second wall 308 may be manufactured from an FR4 material, in one example. The sub-assembly 304, the walls 306 and 308, are disposed on a base or substrate 322. The MEMS die 312 and the ASIC 316 disposed on the lid 302. Alternatively, the ASIC 316 may be disposed on the base 302. A port or opening 323 extends through the lid 302 and into the MEMS 312 under the diaphragm 314 forming a front volume 326. A back volume 328 is formed by the walls 306 and 308, lid 302, substrate 322 and is separated from the front volume 326 by the diaphragm 314. Conductive vias 310 extend through the second wall 308. Conductive paths in the lid 302 couple the ASIC 316 to the vias 310. The vias 310 also couple to conductive traces or paths in the substrate 322. These conductive traces or paths couple to the sub-assembly 304. Thus, an electrical path is provided between the sub-assembly 304 and ASIC 316.

The device 300 is a top port, MEMS-on-lid device (since the port 323 extends through the lid and the MEMS die 312 is attached to the lid 302. As will be appreciated, in this example, the optical sub-assembly 304 is located outside (not enclosed by) of the MEMS die 312 and is positioned below the MEMS die such that the sub-assembly 304 can measure movement of the diaphragm 314. As also will be appreciated, no back plate is required since it is the optical sub-assembly 304 that determines the movement of the diaphragm 314 and hence recovers the incident sound.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A micro electro mechanical system (MEMS) microphone comprising:
a lid;
at least one wall coupled to the lid;
a substrate coupled to the at least one wall and a port extending through the substrate;
a MEMS die disposed on the substrate, the MEMS die including a movable diaphragm and back plate;
an optical sub-assembly coupled to the lid, the optical sub-assembly configured and arranged to sense a position of the diaphragm.

2. The MEMS microphone of claim 1, wherein the optical sub-assembly comprises a laser to emit light and at least one photo detector that detects reflected light that is reflected from the diaphragm.

3. The MEMS microphone of claim 2, wherein the at least one photo detector is configured to detect the intensity of the reflected light.

4. The MEMS microphone of claim 1, wherein the walls include vias.

5. The MEMS microphone of claim 1, further comprising an application specific integrated circuit disposed on the substrate.

6. A micro electro mechanical system (MEMS) microphone comprising:
a lid and a port extending through the lid;
at least one wall coupled to the lid;
a substrate coupled to the at least one wall;
a MEMS die disposed on the lid and over the substrate, the MEMS die including a movable diaphragm and back plate
an optical sub-assembly coupled to the substrate, the optical sub-assembly configured and arranged to sense a position of the diaphragm.

7. The MEMS microphone of claim 6, wherein the optical sub-assembly comprises a laser to emit light and at least one photo detector that detects reflected light that is reflected from the diaphragm.

8. The MEMS microphone of claim 7, wherein the at least one photo detector is configured to detect the intensity of the reflected light.

9. The MEMS microphone of claim 6, wherein the walls include vias.

10. The MEMS microphone of claim 6, further comprising an application specific integrated circuit disposed on the substrate.

11. A micro electro mechanical system (MEMS) microphone comprising:
a lid;
at least one wall coupled to the lid;
a substrate coupled to the at least one wall, and a port extending through the substrate;
a MEMS die disposed on the substrate, the MEMS die including a movable diaphragm and back plate;
an inner housing disposed on the MEMS die;
an optical sub-assembly coupled to or disposed at the inner housing, the optical sub-assembly configured and arranged to sense a position of the diaphragm.

12. The MEMS microphone of claim 11, wherein the optical sub-assembly comprises a laser to emit light and at least one photo detector that is configured to reflected detect light that is reflected from the diaphragm.

13. The MEMS microphone of claim 12, wherein the at least one photo detector is configured to detect the intensity of the reflected light.

14. The MEMS microphone of claim 11, wherein the walls include vias.

15. The MEMS microphone of claim 11, further comprising an application specific integrated circuit disposed on the substrate.
